(19) United States
(12) Patent Application Publication
(10) Pub. No.: US 2016/0091421 A1
(43) Pub. Date: Mar. 31, 2016

(54) REFRACTIVE INDEX BASED MEASUREMENTS

(71) Applicant: TECHNICAL UNIVERSITY OF DENMARK, Kgs. Lyngby (DK)

(72) Inventors: Henrik Schiøtt SØRENSEN, Ølstykke (DK); Thomas Martini JØRGENSEN, Jyllinge (DK)

(73) Assignee: TECHNICAL UNIVERSITY OF DENMARK, Kgs. Lyngby (DK)

(21) Appl. No.: 14/888,391

(22) PCT Filed: Mar. 18, 2014
(86) PCT No.: PCT/EP2014/055439

§ 371 Date: Oct. 30, 2015

(30) Foreign Application Priority Data
Mar. 21, 2013 (EP) 13160346.6

(51) Int. Cl. G01N 21/45

(52) U.S. Cl. CPC G01N 21/45; G01N 2201/0231

(57) ABSTRACT

In a method for performing a refractive index based measurement of a property of a fluid such as chemical composition or temperature, a chirp in the local spatial frequency of interference fringes of an interference pattern is reduced by mathematical manipulation of the recorded light intensity in the interference pattern or by the physical positioning and arrangement of a detector used for capturing the interference pattern.

The present invention relates to methods and apparatus for making refractive index (RI) based measurements by interferometry.

WO2004/023115 and US2006/0012800 disclosed a method of determination of refractive index using micro interferometric back scatter detection (MIBD) also known as back scatter interferometry (BSI) in which light from a laser was directed onto a capillary tube containing a sample liquid and the angular dependence of interference fringes produced by back scattering from the several optical interfaces involved was analysed. In particular, a critical angle was observed at which total internal reflection within the capillary wall caused the intensity of the fringes to drop sharply. An absolute value for the refractive index could be determined.

US 2002/0135772 and Bornhop et al; Science 21^{st} September 2007; Vol 317 describe a method of conducting MIBD using a laser beam directed onto a rectangular cross section channel in a microfluidic chip. Interference fringes were produced which had a position which was dependent on the refractive index of the liquid in the channel, and changes in the refractive index (e.g. upon chemical binding) were seen as a shift in the fringe pattern, so providing a relative measure of the refractive index. Thus, changes in refractive index in the sample can be monitored by observing the movement of fringes in the pattern over time.

Whilst the above disclosures relate to obtaining refractive index based information from interference fringes produced by backscattered light, U.S. Pat. No. 5,251,009 describes a related method in which forward scattered light produces the interference. Laser light is directed onto a fluid filled capillary and scattering occurs at interfaces formed by the capillary and its contents. A detector is provided off the axis of the laser beam, but on the other side of the capillary from the laser to view forward scattered light. Because there will be contributions from the exterior of the capillary acting as an interface which are considered an undesirable complicating factor in the interference pattern, steps are described for subduing such contributions. These involve enclosing the capillary in a fluid filled rectangular box and matching the refractive index of the fluid in the box with that of the glass or other material of the capillary wall. It was desired that the only interfaces contributing to the interference pattern would be those between the interior wall surface of the capillary and its contents.

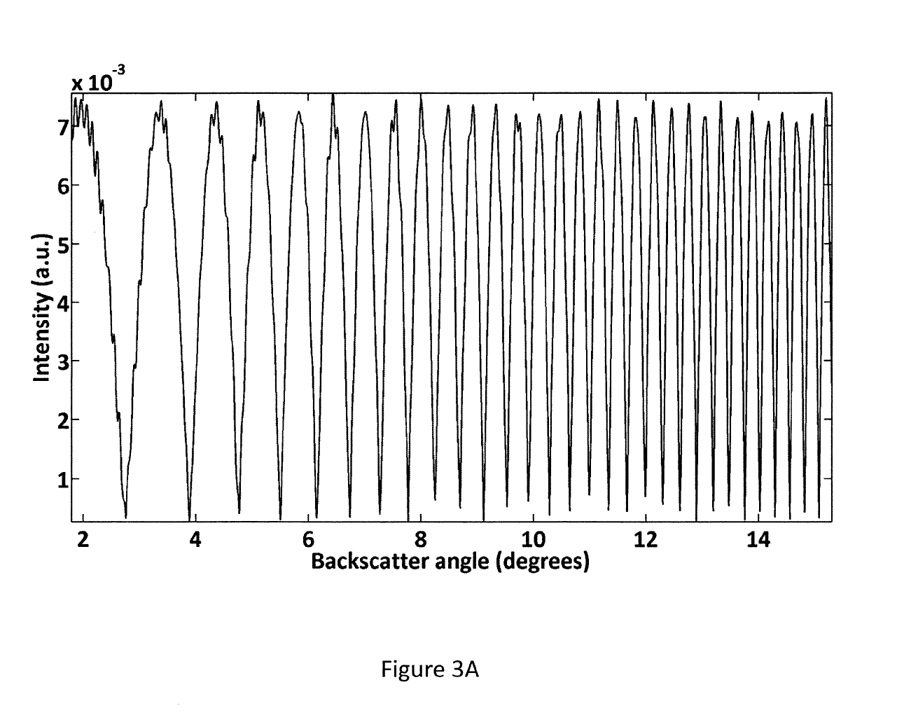

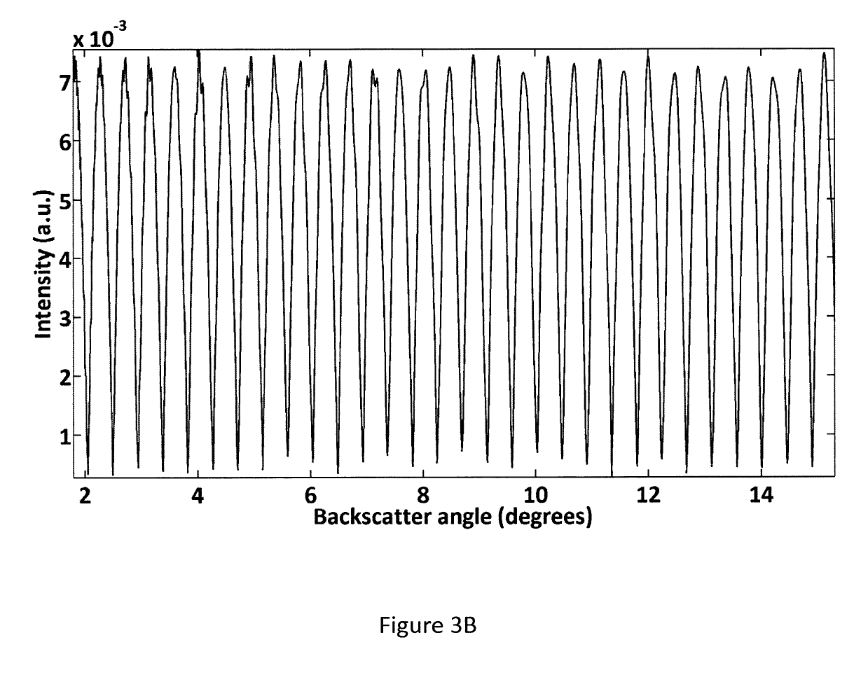

As is seen in FIG. 3 of US2006/0012800, the spacing between the dark and light fringes of the interference pattern produced by BSI is not uniform but changes with distance from the centre of the pattern, i.e. the spatial frequency of the fringe pattern is chirped. The same will apply to fringe patterns generated by forward scattering of the kind dealt with in U.S. Pat. No. 5,251,009.

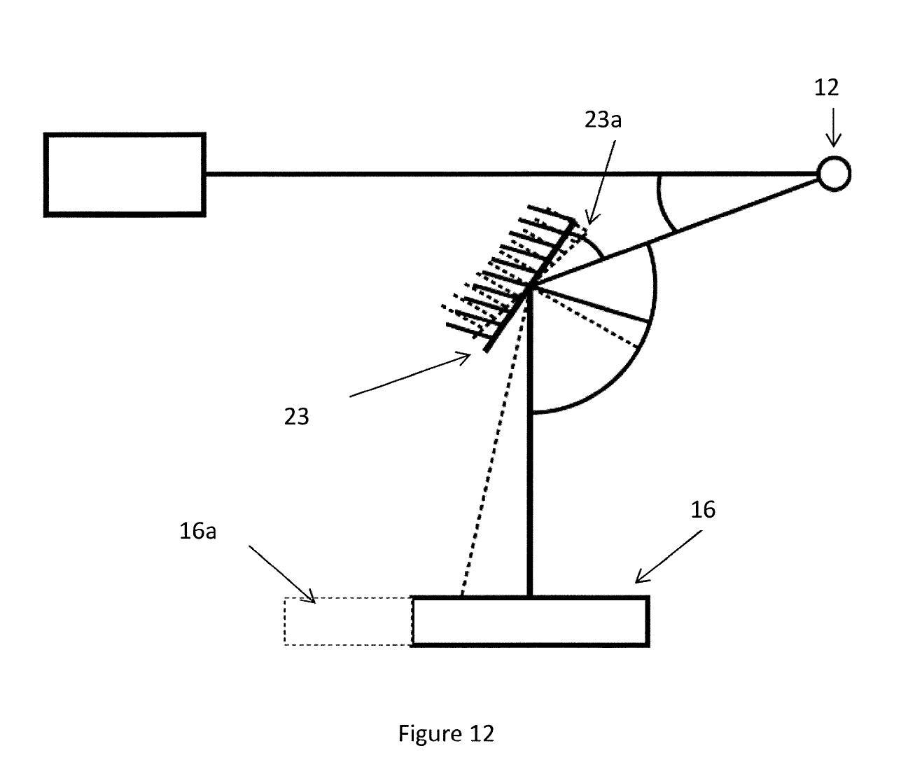

This kind of chirp in the spatial frequency of the fringes is of course very different from the type of chirp illustrated in FIG. 12 of Butheel and Martinez ‘A shattered survey of the fractional Fourier Transform’, Report TW337, April 2002. There one sees a single Gaussian peak corrupted by a higher frequency chirp. A transformation is conducted to filter out the chirp, leaving the Gaussian peak.

In the context of time varying signals, a chirp is a signal in which the frequency increases (‘up-chirp’) or decreases (‘down-chirp’) with time. In this invention, we are concerned with a spatial chirp, i.e. a variation in the intervals between fringes as one moves spatially away from a central origin. What is shown in Butheel et al is not a spatial chirp. It is a superposition of a time varying chirp on a Gaussian peak. The effect of the transformation effected in Butheel et al is not to reduce or remove the chirp in the signal, it is simply to remove the chirped signal itself. So rather than the time varying signal acquiring a more constant frequency, it is simply filtered away and if it had any information content, it would be destroyed.

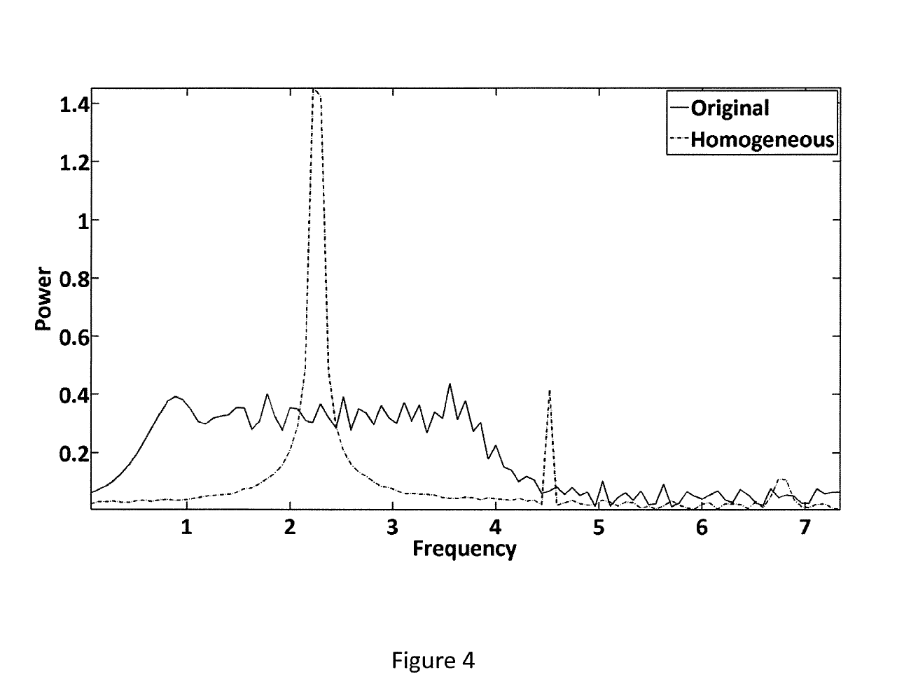

As one moves away from the angle of illumination, the fringes become closer together. The rate of change of spacing with angular distance however falls as one moves to greater angles, so the pattern of brightness/intensity becomes more sinusoidal. As seen in FIG. 4 of US2006/0012800 there is a good deal of fine intensity structure within these medium frequency fringes. When the refractive index of the sample changes, the position of each fringe shifts. A consequence of the spatial chirping of these fringes is that when the refractive index changes and the fringes move, they do not all move at a uniform speed. This is noted by S. S. Dotson in a Dissertation submitted to Vanderbilt University in 2008.

Dotson discloses that if a linear CCD array and a fast Fourier transform (FFT) are used to acquire a fringe pattern, one can determine the positional shift with change in RI. Selecting a slice of pixels from a region of the pattern where the fringe pattern is approximately sinusoidal is necessary because the method is dependent on a constant frequency over the angular region being used. A detection limit of 7×10⁻⁸ RI units (RIU) is said to be possible. Dotson also teaches the use of a cross-correlation technique as an alternative to FFT for analysing the fringe pattern as a means of avoiding being limited to an apparently sinusoidal region of the pattern. Dotson remarks that the fringes in the more sinusoidal area of the pattern do not move so much with changes in RI as fringes nearer the centre of the pattern and this limits the sensitivity.

We have now found that if the fringe pattern is subjected to a mathematical manipulation to remove or reduce the chirp in its spatial frequency and hence to make the speed of movement of the different fringes with RI change more uniform, more of the information content of the fringe pattern can be used and improved accuracy can be obtained in RI based measurements derived from the fringe pattern. Increased robustness and sensitivity is also obtained by avoiding the ambiguity of what frequency to pick from a chirped pattern.

Accordingly, the invention provides a method for performing a refractive index based measurement of a property of a fluid, comprising
directing coherent light along an input light path within an apparatus, producing scattering of said light from each of a plurality of interfaces within said apparatus including interfaces between said fluid and a surface bounding said fluid, said scattering producing an interference pattern formed by said scattered light,
recording varying intensity of light in said pattern in a spatially extending detector crossing the fringes,
wherein said recorded intensity of light comprises alternating light and dark fringes spaced one from another on at least one side of a centroid position, and in the interference pattern, optionally after mathematical transformation, a figure of merit (M) measured over n fringes contained within the first 15 fringes starting from the centroid position is not greater than 0.005, where n is 10,
and obtaining a said refractive index based measurement from said optionally mathematically transformed recorded intensity, M being calculated according to the formula:

M=standard deviation of fringe spacing/(mean spacing of fringes*number of fringes(n)).

It may be noted that the output signal in Butheel et al, or obtainable by any similar technique, would not be such that M could be calculated.

The low degree of spatial chirp defined above in relation to the figure of merit M may be obtained, as described in detail below, in at least two ways. First, a chirp in the recorded intensity variation for which M would be exceeded may be reduced by mathematical transformation. Secondly, the chirp seen in the prior art arrangements may be to some extent avoided by suitable arrangement of the optics of the system, leading to an improved or satisfactory value of M without mathematical transformation. Both methods may advantageously be used in combination.

Accordingly in a first aspect, the present invention provides a method for performing a refractive index based measurement of a property of a fluid, comprising
directing coherent light along an input light path within an apparatus, producing scattering of said light from each of a plurality of interfaces within said apparatus including interfaces between said fluid and a surface bounding said fluid, said scattering producing an interference pattern formed by said scattered light,
recording varying intensity of light in said pattern in a spatially extending detector crossing fringes of said interference pattern,
mathematically transforming said recorded varying intensity of light in said pattern to reduce or remove a chirp in a local spatial frequency of fringes exhibited by said pattern at the detector and thereby producing a modified intensity variation,
and obtaining a said refractive index based measurement from said modified intensity variation.

The invention includes such a method wherein said recorded intensity of light comprises alternating light and dark fringes spaced one from another on at least one side of a centroid position, and in the interference pattern, after said mathematical transformation, a figure of merit (M) measured over n fringes contained within the first 15 fringes starting from the centroid position is not greater than 0.005, where n is 10, M being calculated according to the formula:

M=standard deviation of fringe spacing/(mean spacing of fringes*number of fringes(n)).

In an alternative aspect of the invention, which may be used alone or in combination with said first aspect, the invention provides a method for performing a refractive index based measurement of a property of a fluid, comprising
directing coherent light along an input light path within an apparatus, producing scattering of said light along output paths from each of a plurality of interfaces within said apparatus including interfaces between said fluid and a surface bounding said fluid, said scattering producing an interference pattern formed by said scattered light which has a local spatial frequency,
recording varying intensity of light in said pattern in a spatially extending detector crossing the fringes, wherein the detector and any optics intervening between the detector and the said interfaces are so arranged that a chirp in the local spatial frequency observed at the detector is no greater than would be observed if the intensity of light following said output paths was recorded on a detector extending orthogonally to said input light path without any optics intervening between the said detector and said interfaces,
and obtaining a said refractive index based measurement from said recorded intensity variation.

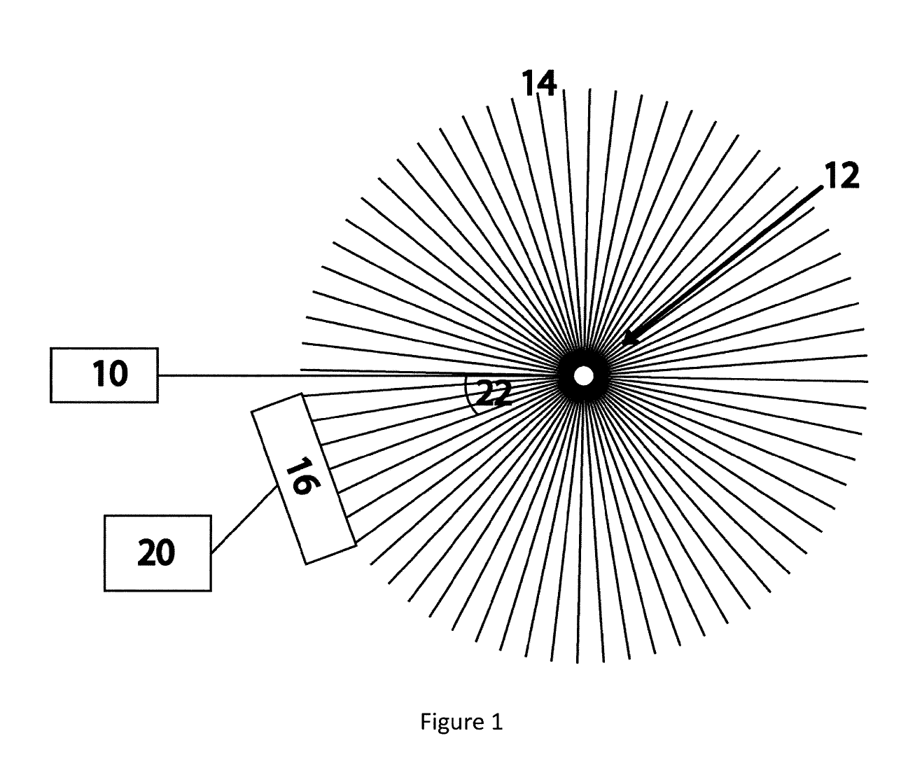

Compared to what is seen in FIG. 1 of US2006/0012800, the optical arrangement of the detector according to the second aspect of the invention is such that the variation in local frequency or chirp of the fringes at the detector is reduced. This may be brought about by the positioning of the detector directly or by the positioning of one or more mirrors between the sample location and the detector.

Where the light from the sample reaches the detector directly, the detector is angled so as to be orthogonal to the return path from the sample to the laser or more preferably at an oblique angle to it, rather than at the acute angle shown in FIG. 1 of US2006/0012800. Where one or more mirrors are interposed between the sample location and the detector, they and the detector are positioned to achieve a similar effect.

The invention includes such a method according to the second aspect of the invention wherein said recorded intensity of light comprises alternating light and dark fringes spaced one from another on at least one side of a centroid position, and in the interference pattern, after said mathematical transformation, a figure of merit (M) measured over n fringes contained within the first 15 fringes starting from the centroid position is not greater than 0.005, where n is 10, M being calculated according to the formula:

M=standard deviation of fringe spacing/(mean spacing of fringes*number of fringes(n)).

As briefly indicated above, according to either aspect of the invention, a convenient measure of the chirp is proportional to the standard deviation of the observed fringe distances divided by the average fringe distance. The minimum desideratum is that this figure of merit is improved compared to the standard setup. The extent of the chirp amongst a group of n adjacent fringes may be quantitated as a figure of merit (M) calculated as:

M=standard deviation of fringe spacing/(mean spacing of fringes*number of fringes(n)).

Preferably, the figure of merit (M) measured over n fringes contained within the first 15 fringes starting from the centroid position, where n is 10 is not greater than 0.005, more preferably not greater than 0.001. The ten fringes used in calculating M may be fringes 5-15. Of course, provided that this is true of the fringe pattern, optionally after said mathematical transformation, there is no necessity that the actual refractive index based measurement of the property in question should be calculated from observation of the first 15 fringes or any subset of them. Neither is it required that the measured light intensities should include the centroid position or fringes on both sides of it.

Where according to the first aspect of the invention, the chirp is reduced from a starting value by mathematical manipulation of the data, the improvement obtained in the figure of merit M calculated as above is preferably at least a factor of 2, more preferably at least a factor of 10, and still more preferably at least a factor of 20.

According to a preferred practice of the first aspect of the invention said mathematically transforming step is performed in a suitably pre-programmed computation apparatus.

According to a preferred practice of the first aspect of the invention said mathematically transforming step is conducted by applying a coordinate transformation to said recorded varying intensity of light along the detector.

Preferably, a frequency spectrum is obtained for the spatial frequencies of the fringes in said recorded intensity, a maximum peak amplitude value of said frequency spectrum is determined, a first offset value (x_{offset}) is chosen by which to transform a coordinate (x) of intensity values in said recorded varying intensity of light along the detector and said coordinate transformation is carried out using said first offset value, the frequency spectrum and the peak amplitude value thereof are obtained again and compared with their previous values and the process is repeated using different offset values to obtain a value of the offset value that increases the maximum peak amplitude value.

Alternatively, the chosen offset may be obtained by measurement carried out on the apparatus.

In a method according to the first aspect of the invention, as in the second aspect, the detector and any optics intervening between the detector and the said interfaces may be so arranged that said chirp in the local spatial frequency at the detector prior to said mathematical transformation is no greater than would be observed if the intensity of light following said output paths was recorded on a detector extending orthogonally to said input light path without any optics intervening between the said detector and said interfaces.

In any such method, the optics may be fixed in position or may be adjustable, in which case preferably a frequency spectrum is obtained for the spatial frequencies of the fringes in said recorded intensity, the arrangement of the detector and any optics intervening between the detector and the said interfaces is adjusted, the frequency spectrum and the peak amplitude value thereof are obtained again and compared with their previous values and the process is repeated to obtain a said arrangement that increases the maximum peak amplitude value. An offset value may be selected that provides the maximum value obtained for the maximum peak amplitude value.

Suitably, the adjustment of said arrangement of the detector and any optics intervening between the detector and the said interfaces is a rotation of the detector or a rotation of a reflective optical component intervening between the detector and said interfaces.

In a method according to either aspect of the invention said apparatus optionally includes a flow path for the supply of a fluid to a location where the fluid meets the input light path and a flow path for removal of said fluid from said location. The method may include a step of driving a flow of fluid through said location.

The method may further comprise operating a temperature control means to maintain said fluid at a desired constant or varying temperature.

Preferably, the interference pattern is detected at a position where it is formed by backscattered light.

According to all aspects of the invention, the fluid may be a liquid.

For use in the first aspect of the invention there may be provided apparatus for use in performing a refractive index based measurement of a property of a fluid, by a method comprising directing coherent light along an input light path within said apparatus, producing scattering of said light from each of a plurality of interfaces within said apparatus including interfaces between said fluid and a surface bounding said fluid, and detecting properties of an interference pattern formed by said scattered light which interference pattern has a local spatial frequency of fringes exhibiting a chirp,

wherein said apparatus comprises
a source of coherent light for directing light along an input light path, at least one cavity in said input light path for containing a said fluid and defining said plurality of interfaces, a spatially extending detector positioned to sense light forming a said interference pattern of fringes produced by scattering from said interfaces in use and to produce an electronic output in response thereto which provides a recording of varying intensity of light in said interference pattern with respect to a spatial direction crossing the fringes, and computation means operatively connected to receive said electronic output for determining therefrom said measured property, said computation means being pre-programmed to remove or reduce a said chirp exhibited by a spatial frequency of recorded fringes in said recording by a method comprising mathematically transforming said recorded varying intensity of light in said pattern to reduce or remove said chirp and thereby to produce a modified intensity variation, and obtain a said refractive index based measurement from said modified intensity variation.

Optionally, the detector and any optics intervening between the detector and the said interfaces are so arranged that said chirp in the local spatial frequency at the detector prior to said mathematical transformation is no greater than would be observed if the intensity of light following said output paths was recorded on a detector extending orthogonally to said input light path without any optics intervening between the said detector and said interfaces.

For use in the second aspect of the invention there may be provided apparatus for use in performing a refractive index based measurement of a property of a fluid, by a method comprising directing coherent light along an input light path within said apparatus, producing scattering of said light from each of a plurality of interfaces within said apparatus including interfaces between said fluid and a surface bounding said fluid, and detecting properties of an interference pattern formed by said scattered light which interference pattern has a spatial frequency of fringes exhibiting a chirp,

wherein said apparatus comprises
a source of coherent light for directing light along an input light path, at least one cavity in said input light path for containing a said fluid and defining said plurality of interfaces, a spatially extending detector positioned to sense light forming a said interference pattern of fringes produced by scattering from said interfaces in use and to produce an electronic output in response thereto which provides a recording of varying intensity of light in said interference pattern with respect to a spatial direction crossing the fringes, wherein the detector and any optics intervening between the detector and the said interfaces are so arranged that said chirp in the local spatial frequency at the detector prior to said mathematical transformation is no greater than would be observed if the intensity of light following said output paths was recorded on a detector extending orthogonally to said input light path without any optics intervening between the said detector and said interfaces,
and computation means operatively connected to receive said electronic output and to obtain a said refractive index based measurement therefrom.

Preferred features of such apparatus may be as described in connection with the methods of the invention.

Preferably, the said cavity containing said fluid has a transverse dimension in the direction of the input light path of from fpm to 10 mm, optionally from 0.5 mm to 3 mm, more preferably from 1 to 2 mm.

The method and the apparatus according to the invention are each broadly applicable to BSI measurements and to forward scattering measurements (FSI) and are not restricted to any one specific apparatus geometry. Thus, the sample chamber may be circular or non-circular in cross-section traversed by the light and may be a free standing tube or may be a channel in a substrate or other form of cavity. Non-circular section chambers, which may be channels, may for instance be semi-circular or rectangular in transverse section. In particular, the parts of the apparatus used other than the computation element may be as described in any of the references acknowledged herein. BSI arrangements are preferred. Sample chambers allowing a flow through of sample are preferred, e.g. channels or tubes.

The invention provides in each of its aspects a method for converting an observed fringe pattern recorded in a BSI or FSI measurement to a single frequency sinusoidal fringe pattern with a phase value that changes uniformly with change of the refractive index of the liquid within a channel containing the measuring sample. Calculations with regard to the sensitivity of the measurement in response to a change in refractive index suggest that the cross section of the sample chamber as traversed by the light should be as large as the detection volume (sample volume) allows. This means that a transverse dimension of 1-2 mm (or a cross section of 0.75 to 3 mm² for circular shaped channels) is preferred to sub-millimetre transverse dimension sizes.

In practising the invention, one should preferably use exclusively or in part fringes close to the centroid part of the formed fringe pattern, for instance fringes within the first 15 fringes. Being close to the centroid, the need for the homogenization of the fringe pattern (unchirping it) is even more critical.

The benefit of obtaining a single frequency fringe pattern with a uniform phase change reflecting the refractive index change of the measurement sample is that one can take advantage of a large fringe region in estimating the phase change (thereby estimating the change in refractive index). By this means, one can get a more robust estimation suppressing the effect of noise. Examples of methods of estimating the phase change include using a FFT like algorithm or a correlation method. If the fringe frequency is not constant and the phase change is not uniform along the fringe pattern the conditions for applying both an FFT approach and a correlation-based method will not be fulfilled. Accordingly the estimated change in refractive index will be biased. By use of the invention these bias errors will be reduced, ideally to a minimum.

By increasing the ratio of the traversed path length of the light through the channel to the optical wavelength, the validity of assuming the phase change is constant for a given number of observed fringes improves. In addition the direct sensitivity increases as the actual phase change increases for a given change in the refractive index of the liquid sample.

Optionally, two similar sample chambers are provided in close proximity and each is similarly illuminated by a respective or common light source to provide a similar interference pattern such that one interference pattern may operate as a reference channel for the other. Thus, for instance, if the sample in one chamber is kept constant in nature and the sample in the other chamber is allowed to vary, the variations may be isolated from the effects of factors influencing both chambers such as temperature change.

Computation apparatus used in the methods described above or forming part of apparatus according to the invention may be programmed computation means suitably programmed for also processing the modified (de-chirped) intensity variation to extract from it the desired refractive index based measurement. This may be an absolute value of refractive index. It may be a shift in refractive index consequent upon a change in the fluid. Such an absolute or relative value of refractive index may be converted to units of another parameter, such as temperature or substance concentration, by the use of a suitable calibration curve, look up table or the like by the computation apparatus.

Computation of the desired measurement from the modified intensity variation may be by FFT, cross-correlation, pattern recognition or other such known methods.

All of the apparatus features described above in connection with the method of the invention may be used in such apparatus.

Fluids may be driven through the cavity or cavities of the apparatus where desired by the action of a suitable fluid flow driving means, which may be a pump, such as a syringe pump or peristaltic pump, or may be passive capillary forces, or may be means for producing electro-osmotic flow by the application of voltage.

The apparatus may as indicated above include a temperature controller for maintaining the sample in the light path at a desired temperature. This may be a Peltier or other temperature control device and preferably includes a temperature sensor operatively connected to a device for heating and/or for cooling said sample.

References to refractive index determination herein should be understood where the context permits to include absolute refractive index measurement and also relative refractive index measurements (i.e. measurements of the difference between the refractive index of one material and that of another, or temporal changes in refractive index of one material). Refractive index measurements need not be expressed in refractive index numbers but may be translated into some other quantity which affects refractive index such as sample temperature or solute concentration. Thus, through their effect on refractive index one can measure temperature, pressure, concentration and molecular interactions, thereby obtaining thermodynamic and kinetic information for specific types of molecules which may include cytokines, hormones, immunoglobulins, C-Reactive Protein, enzymatic reactions and troponin, as well as polynucleotides by way of example.

The invention will be further described with reference to and as illustrated in the accompanying drawings, in which:

FIG. 1 shows a schematic arrangement of apparatus for performing an MIBD or BSI refractive index determination;

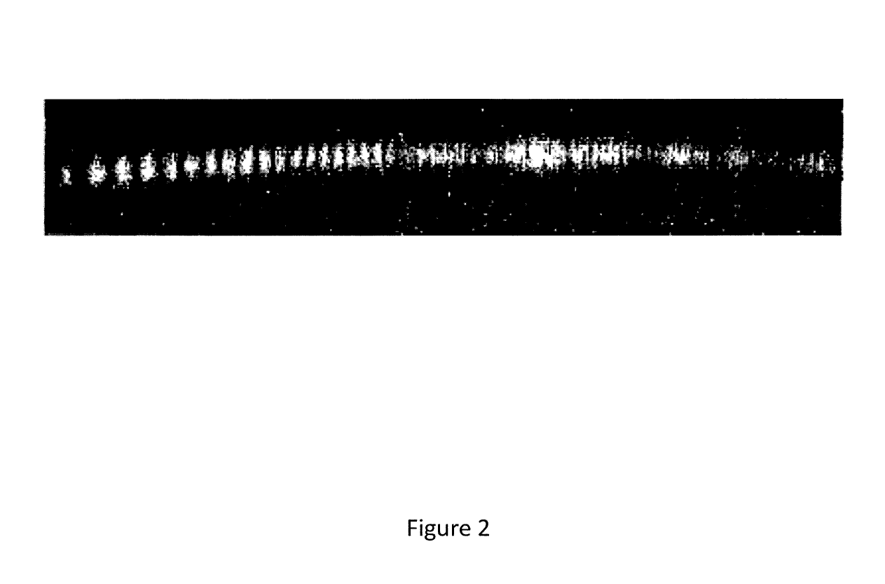

FIG. 2 shows an example of an interference pattern experimentally observed using the apparatus of FIG. 1;

FIG. 3A shows a simulation of the kind of pattern seen in FIG. 2 in the form of a trace of intensity against angular position within the pattern before transformation according to the invention;

FIG. 3B shows a simulation of the pattern seen in FIG. 3A after transformation according to the invention;

FIG. 4 shows the power spectrum of each pattern seen in FIG. 3. The power spectrum of the pattern of FIG. 3A is shown with a full line and that of FIG. 3B with a dotted line;

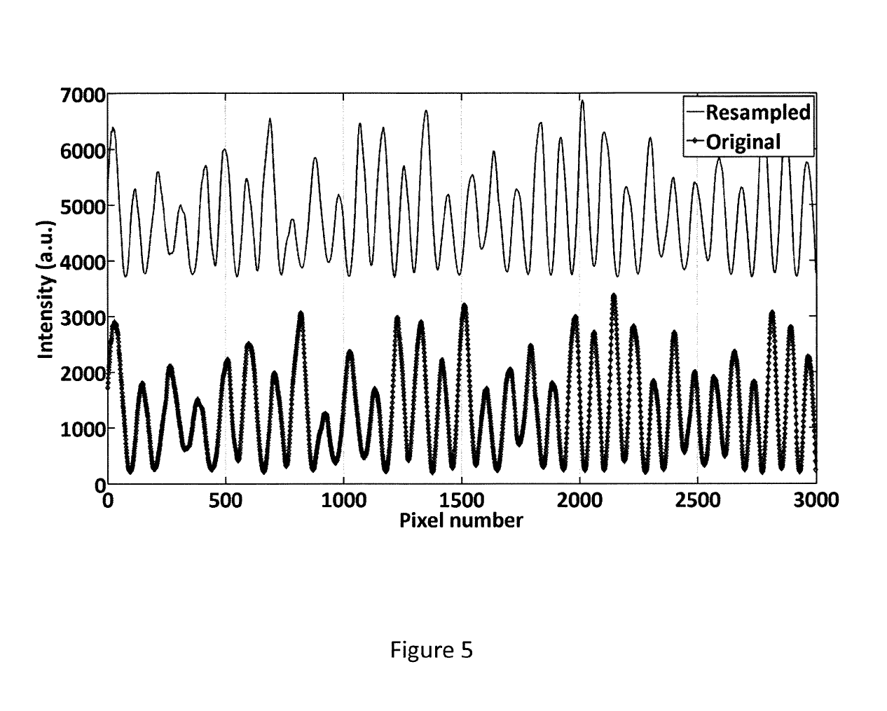

FIG. 5 shows an experimentally obtained pattern of the kind shown in FIG. 3A (lower trace) and of the kind shown in FIG. 3B (upper trace), the upper trace being after dechirping according to the invention and the lower trace being before;

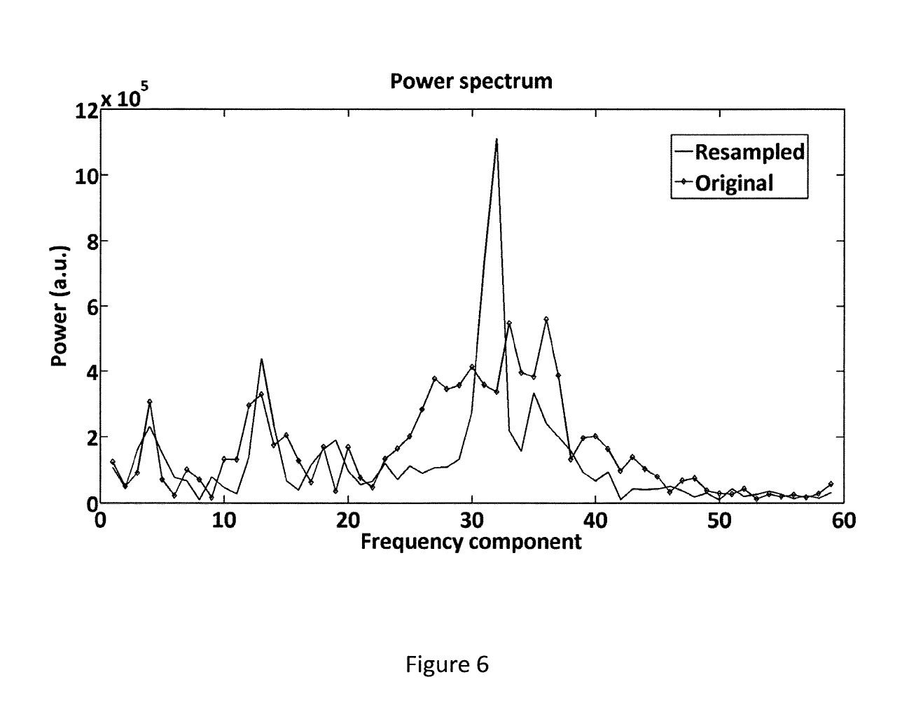

FIG. 6 shows the power spectrum of each of the upper and lower traces of FIG. 5;

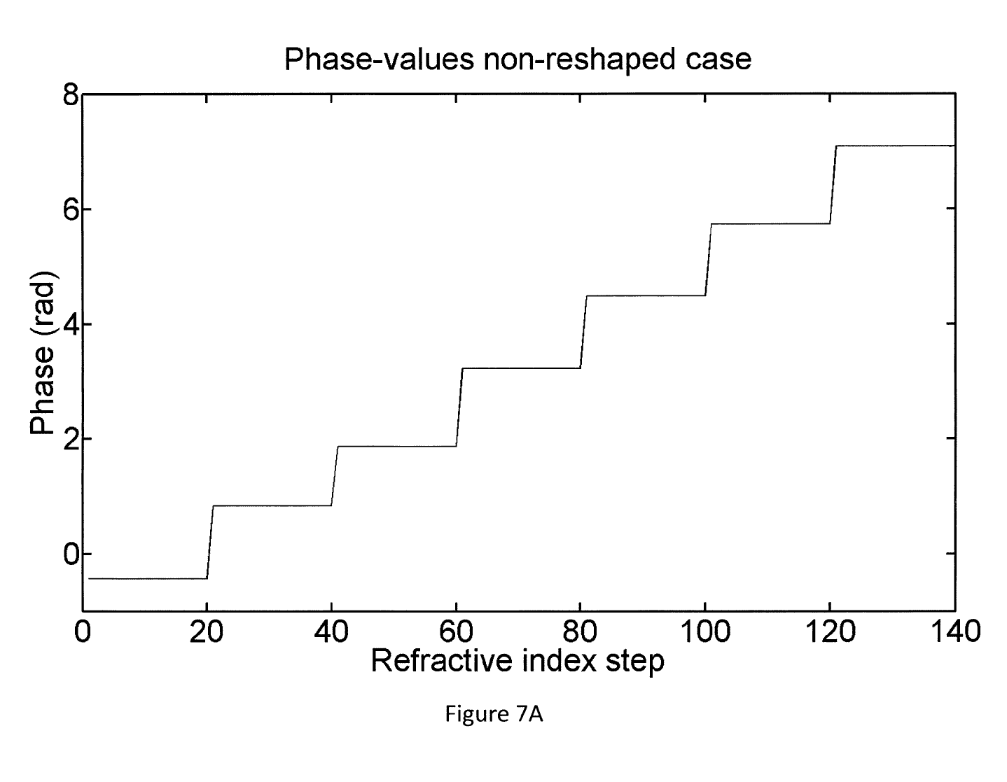

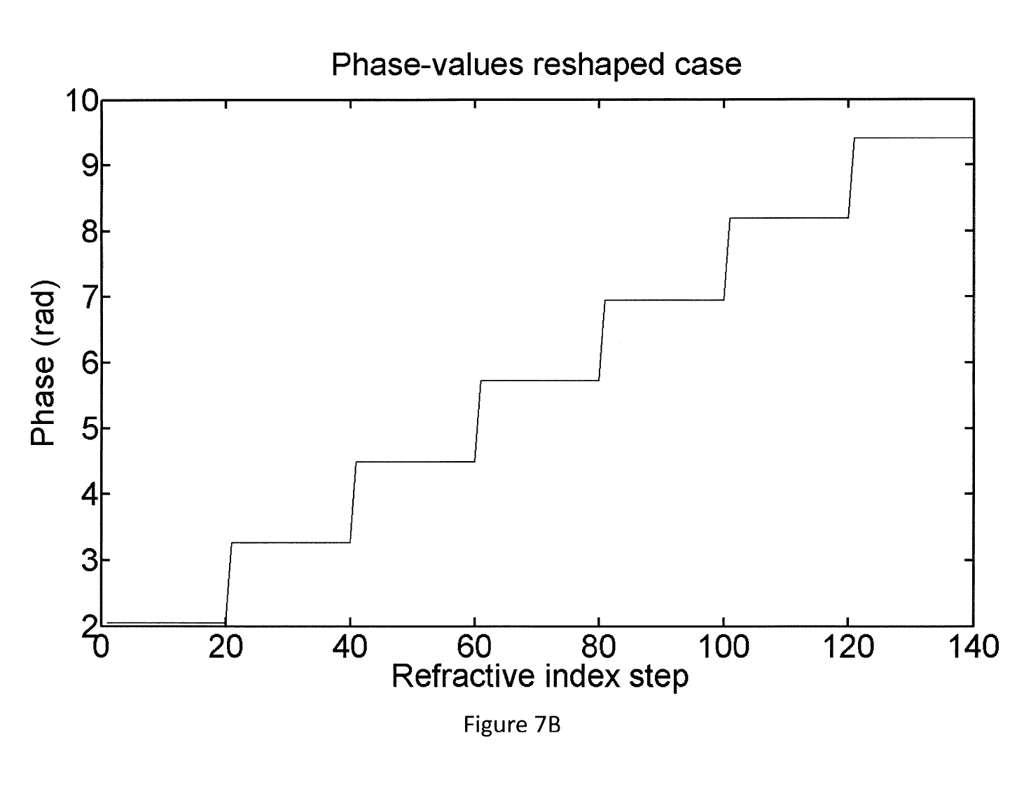

FIG. 7 shows in panel A simulated changes in the phase values of the largest amplitude peak in a power spectrum before dechirping and shows in panel B the same changes after the reshaping of the pattern according to the invention;

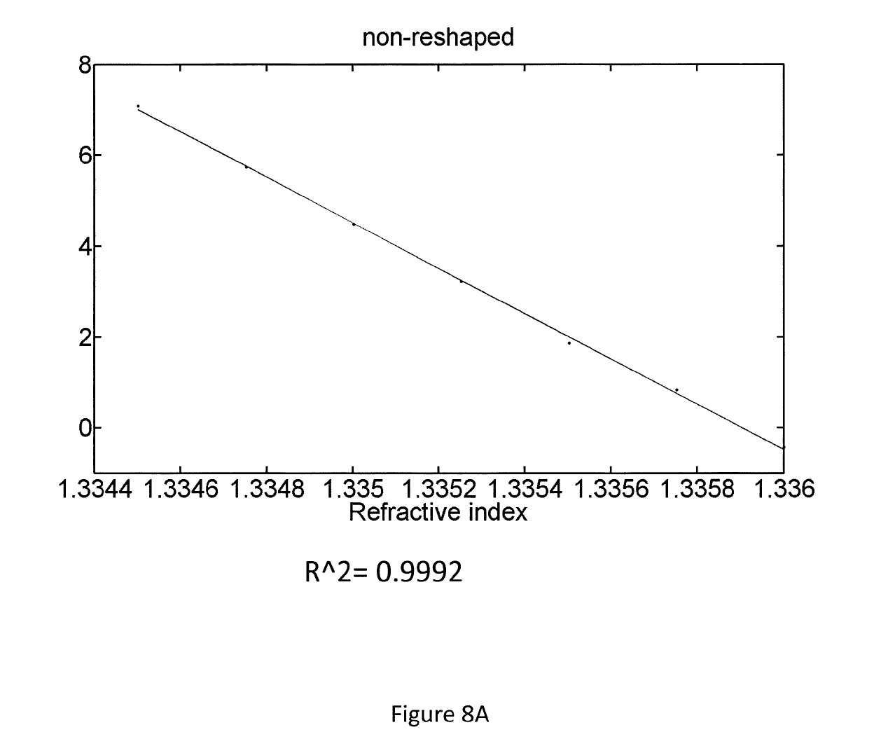

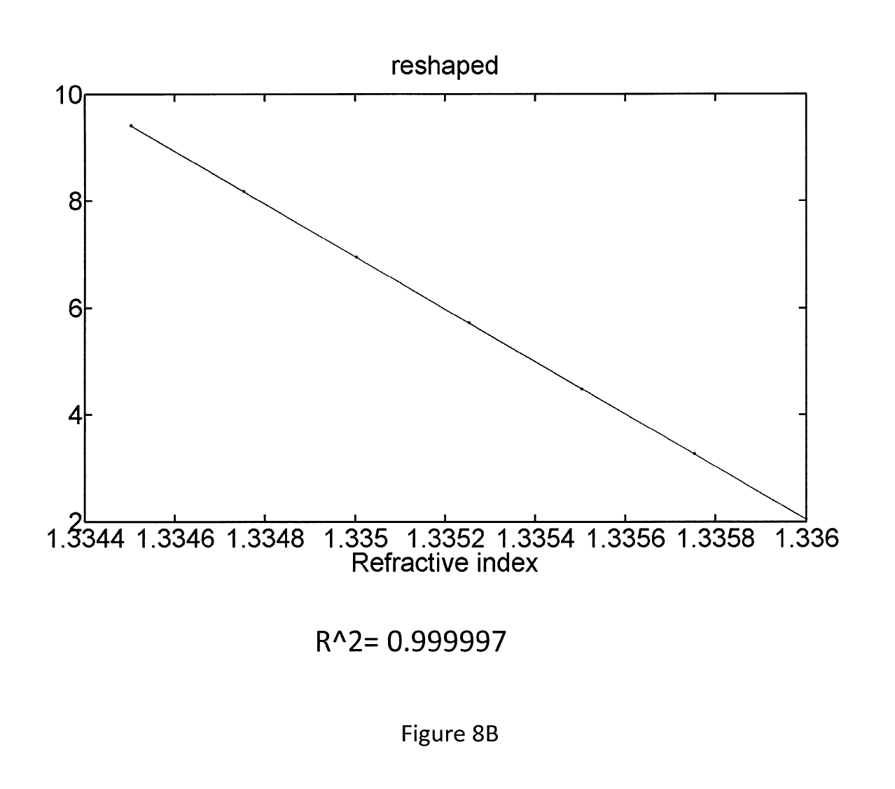

FIG. 8 shows in panel A a simulated calibration curve for BSI measurement of RI changes in a sample based on FIG. 7, panel A and shows in panel B a similar simulation based on FIG. 7, panel B;

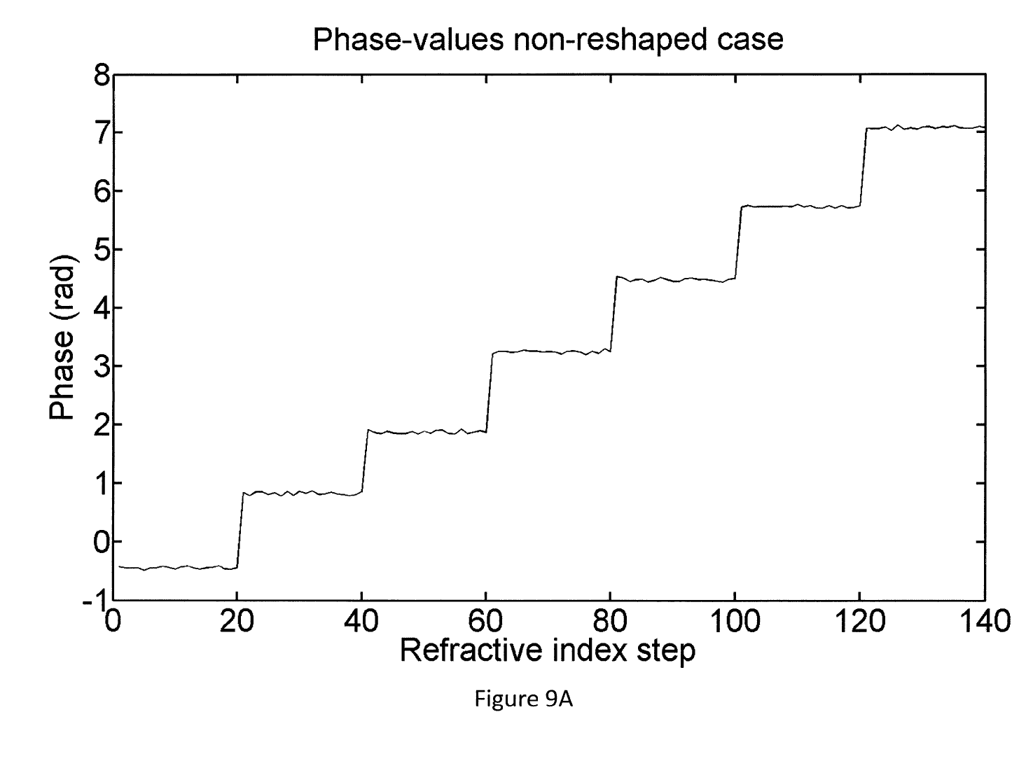

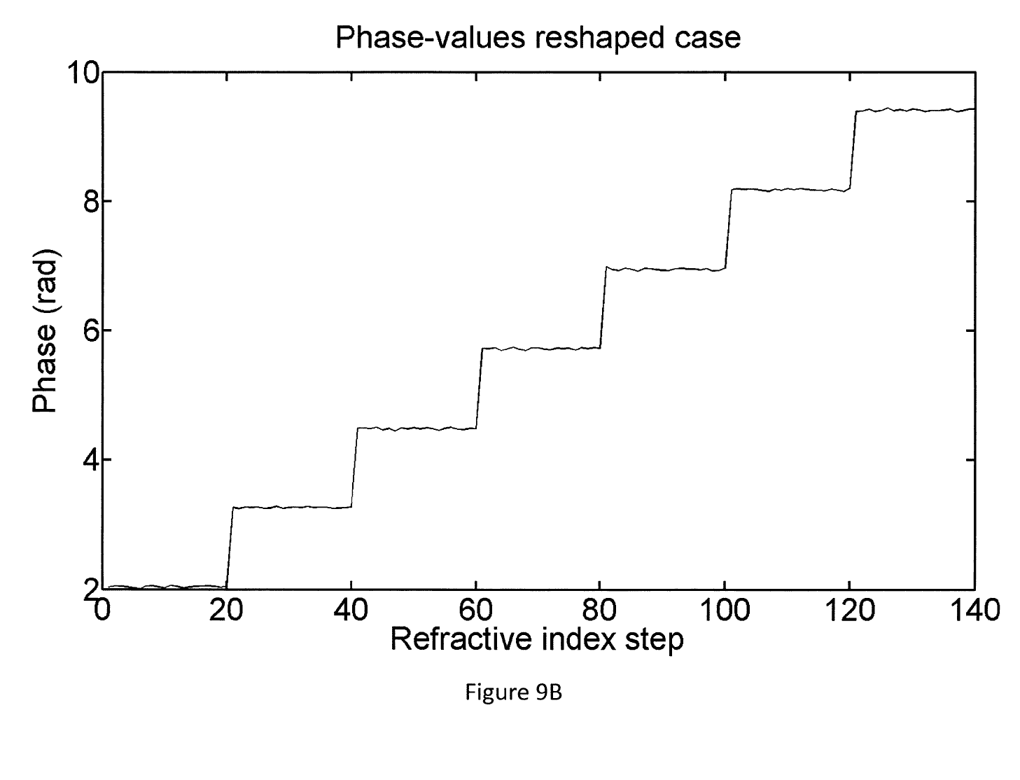

FIG. 9 is similar to FIG. 7, but a larger amount of noise has been included in the simulation.

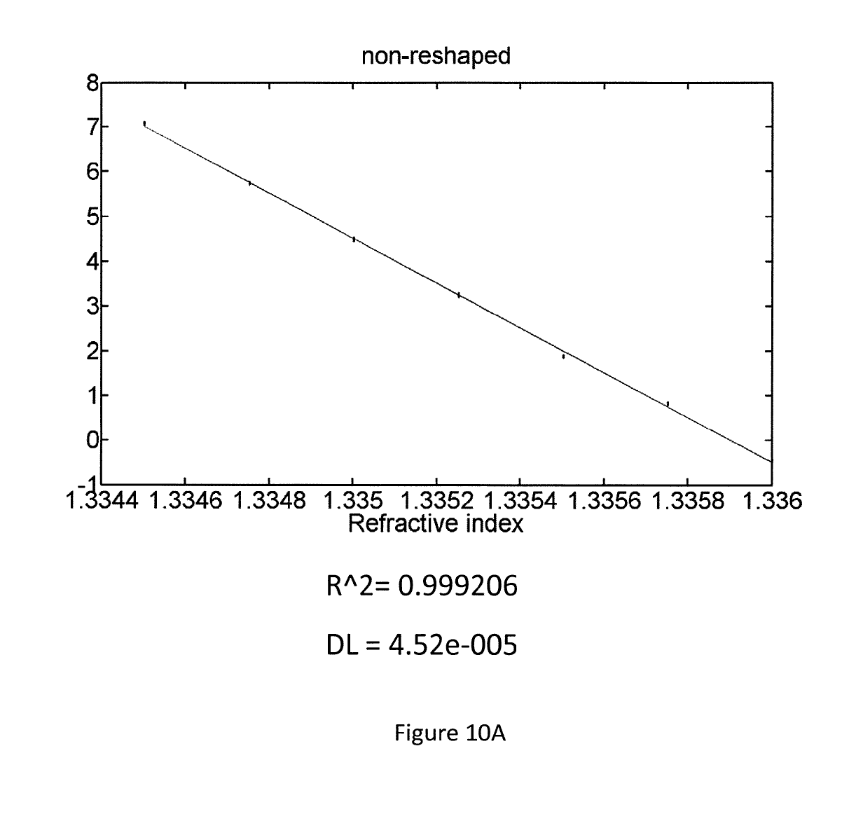

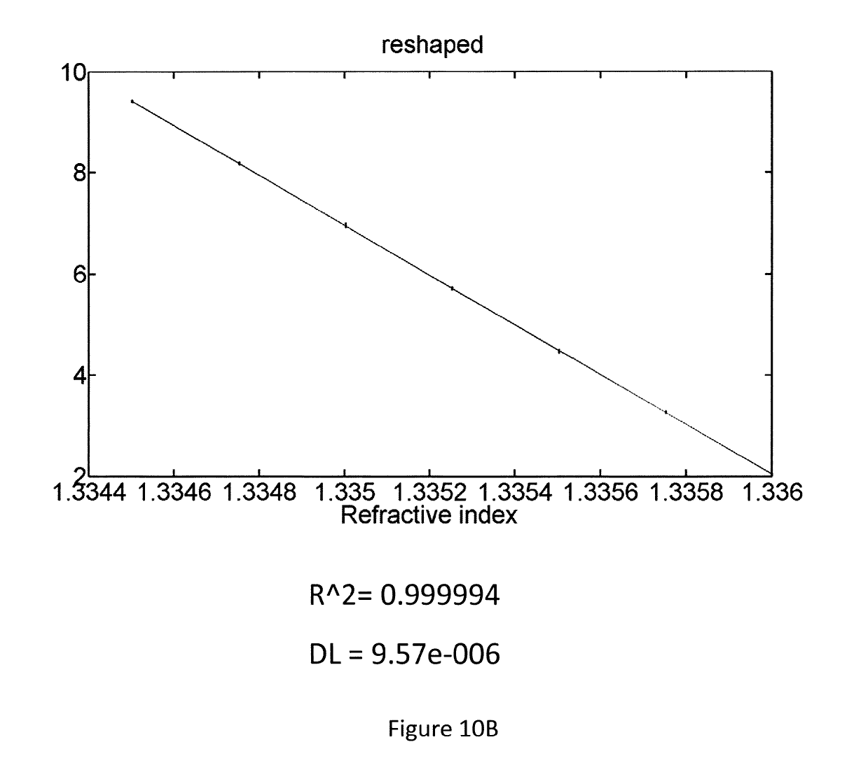

FIG. 10 shows calibration curves derived from FIG. 9.

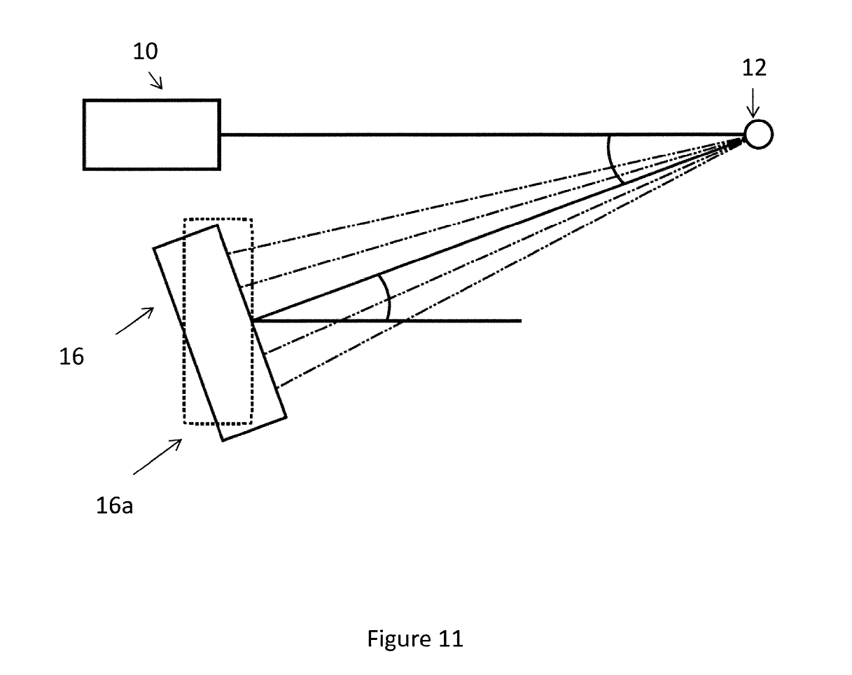

FIG. 11 shows a schematic layout of apparatus according to a first embodiment of a second aspect of the invention;

FIG. 12 shows a schematic layout of apparatus according to a second embodiment of a second aspect of the invention;

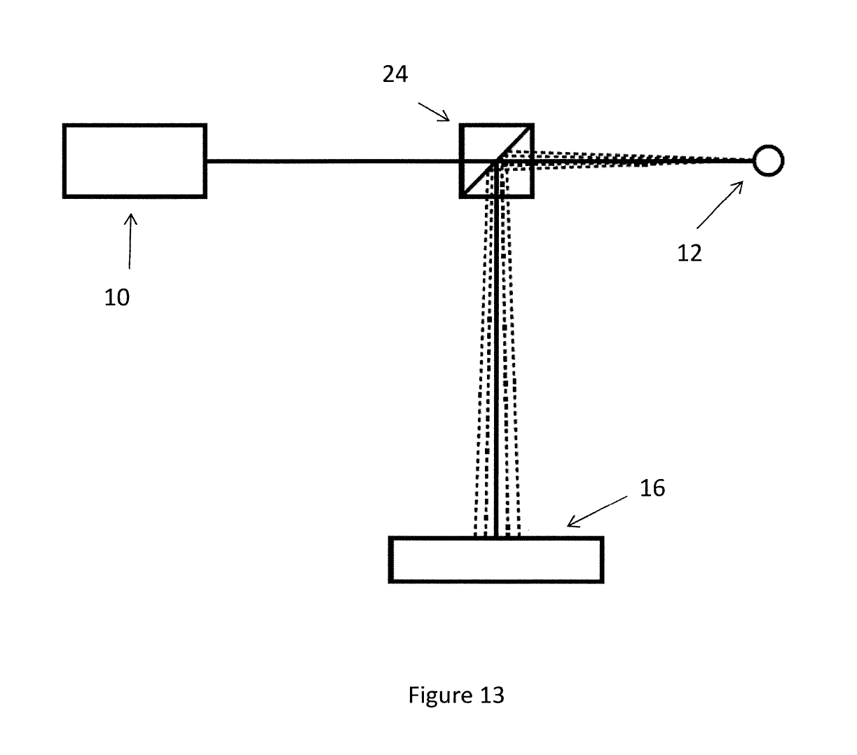

FIG. 13 shows a schematic layout of apparatus according to a third embodiment of a second aspect of the invention;

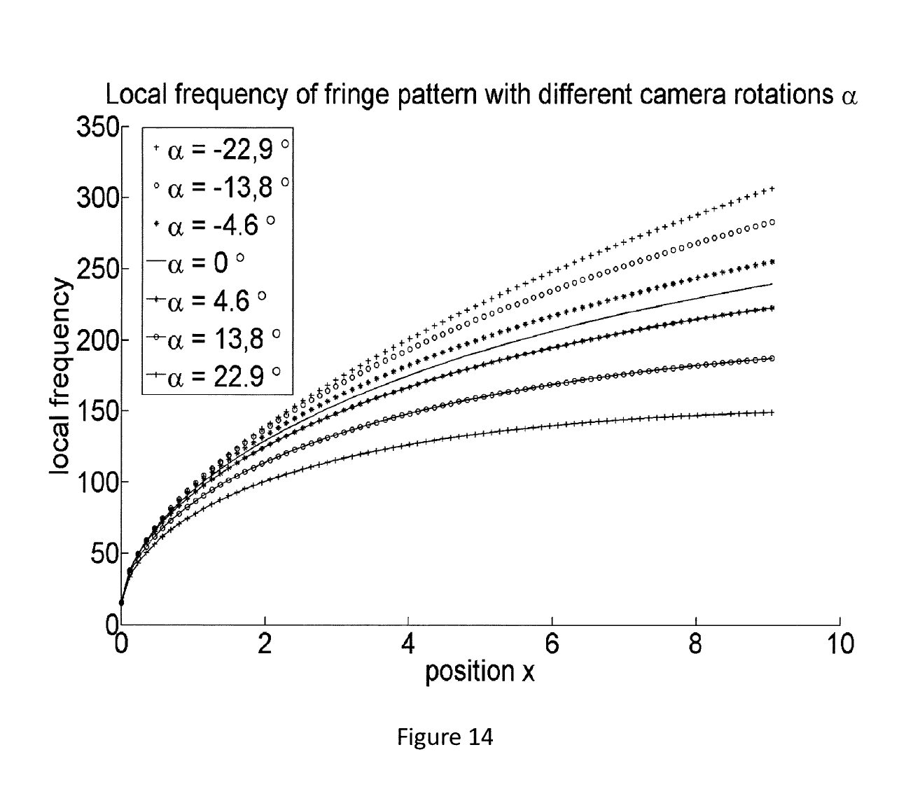

FIG. 14 shows the calculated chirp as a change in local frequency with distance from the centroid of an interference pattern at various angles of a detector;

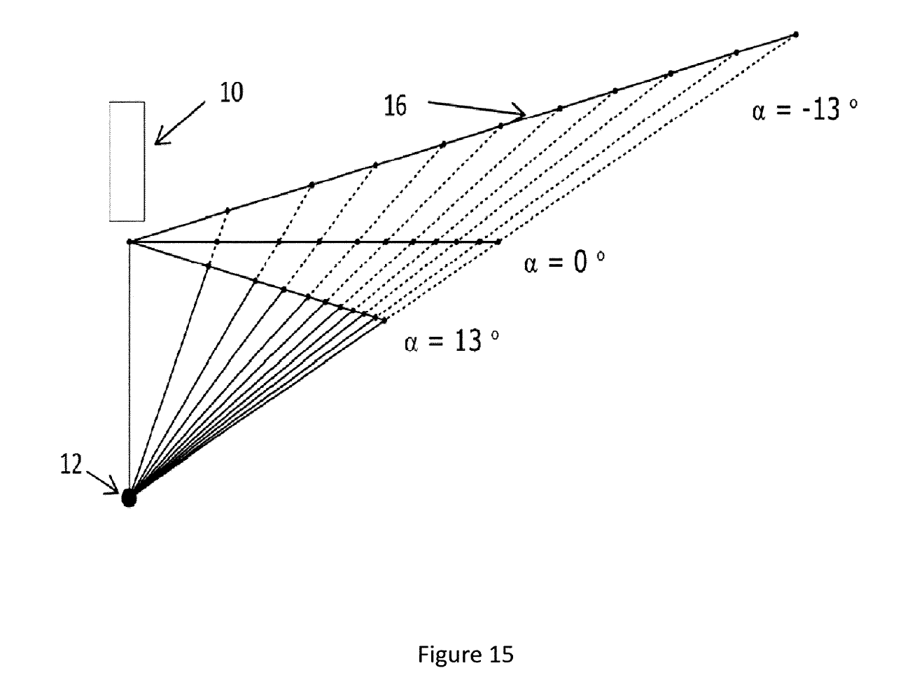

FIG. 15 illustrates the effect of three different detector orientations on the spacing of fringe light intensity maxima on a detector;

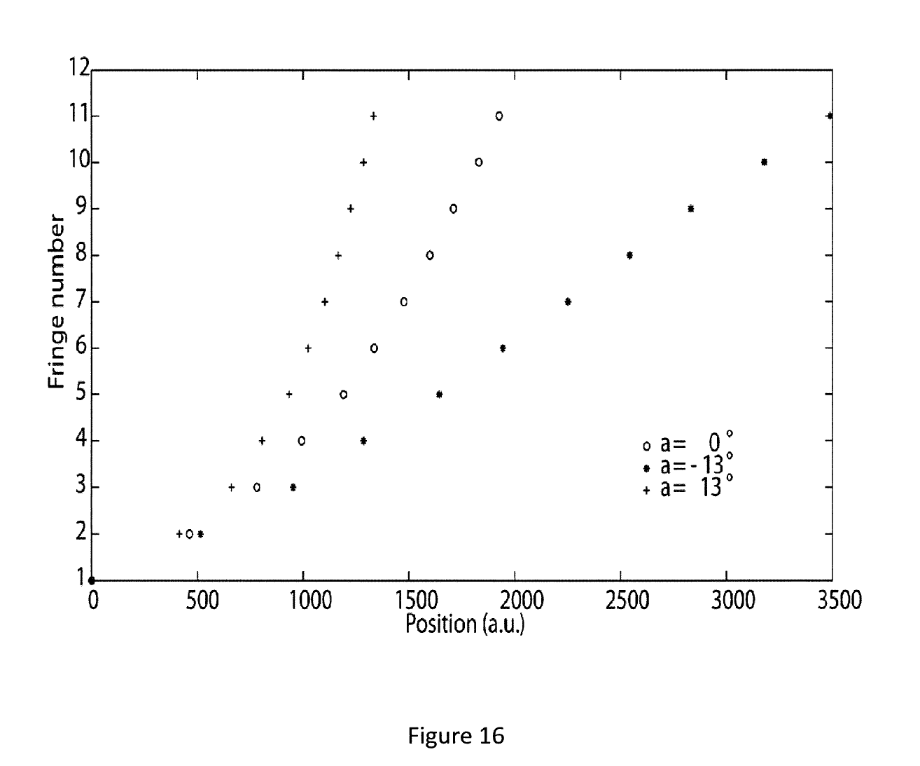

FIG. 16 shows the chirp obtained in the three cases illustrated in FIG. 15; and

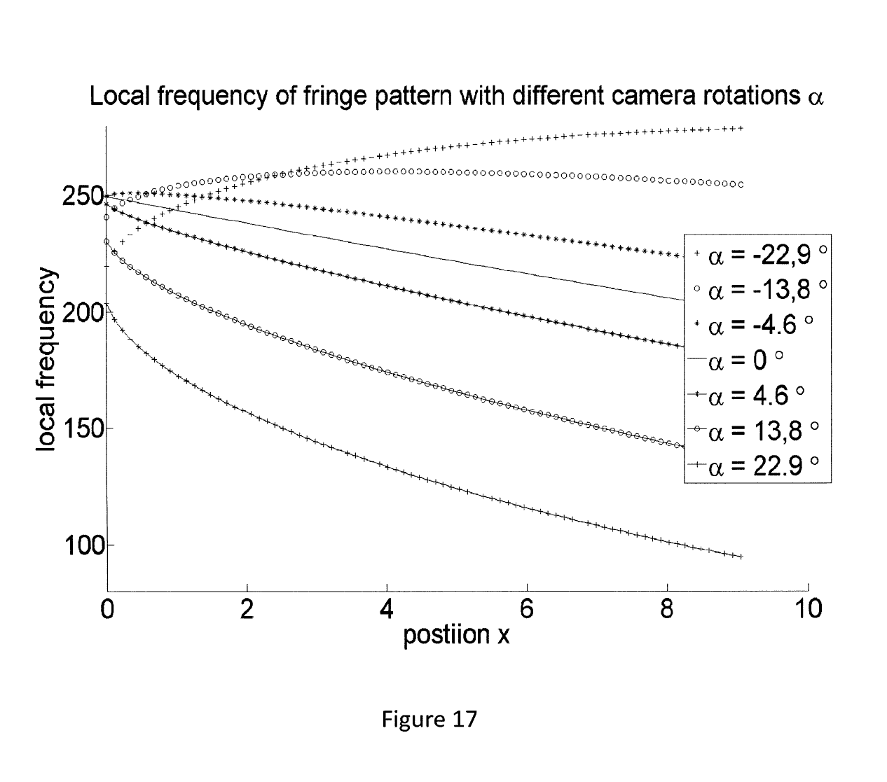

FIG. 17 is similar to FIG. 14 but shows the calculated chirp when using both mathematical compensation and variable angle of detector in combination.

FIG. 1 illustrates the principles of MIBD or BSI. A laser 10 directs a beam towards a capillary tube 12 containing a sample liquid. Light is scattered from interfaces between air and the capillary wall material, and between the wall material and the liquid, over a range of angles 22. When viewed from an observation point on the same side of the tube as the laser at a CCD array 16, or a CMOS array, or other spatially extending detector the backscattered light forms interference fringes as seen in FIG. 2, and these can be recorded in a computer 20 for analysis. If this were an FSI arrangement, the detector array would suitably be in a position diametrically across the tube 12 from where it is in the figure. The detector array may be within a camera pointed directly at the tube at a selected angle to the laser light beam.

The plot of the intensity of the pattern against the angle 22 from the axis of the illuminating beam will be generally as in the simulation shown in FIG. 3A.

It can be seen that the fringes become more closely spaced as one moves away from the axis (0 position). Less obvious to visual inspection is that the rate of change of spacing decreases so that the spacing is more uniform at high values on the abscissa scale.

A consequence of this chirping is that when the refractive index of the sample liquid changes and as a result the position of the fringes changes with all of the fringes stepping to the right or left, the speed of movement of the differently spaced fringes will not be uniform. More widely spaced fringes will move faster than the more closely spaced ones.

FIG. 4, full line, shows a power spectrum for the variation of intensity with angular position seen in FIG. 3A. Because of the variation in spacing of the fringes (chirp), the power spectrum contains a number of peaks of similar magnitude between the abscissa values of 1 and 4.

The intensity pattern seen in FIG. 3A can be modelled by the equation:

I(x)≅D sin(a(x+x_{offset})²+θ)+E (I)

Where I is the intensity, x describes the angular coordinate of observation and a, x_{offset}, D, E are constants and θ is a phase term, dependent on refractive index of the sample liquid.

We aim to make a coordinate transformation:

t=(x+x_{offset})² (II)

to produce an unchirped fringe pattern:

I(t)≅D sin(at+θ)+E (III)

To do this it is necessary to estimate an appropriate value to use for x_{offset}.

This problem may be solved as follows:
A range of x_{offset} is searched (in an intelligent way) to find the value of x_{offset} that maximizes to a given precision the maximum peak amplitude value (above the DC region) in the spatial frequency spectrum of the recorded fringe pattern by applying the variable transformation x ->t.
With the estimated value of x_{offset} we remap the abscissa for the recorded fringe pattern. Interpolated values of the fringe pattern for coordinate values between the remapped x-values can eventually be estimated by interpolation/resampling.

The effect of this is seen in FIG. 4, where the plot in dotted line shows the changed power spectrum. As better values for x_{offset} are tried, so the maximum peak amplitude increases and the number of peaks having a substantial share of the power decreases until the position illustrated is reached.

The effect of this on the plotted fringe pattern itself is seen in FIG. 3B. The peak spacing has become uniform, or substantially so.

A consequence of this is that when the refractive index of the sample liquid changes and as a result the position of the fringes changes with all of the fringes stepping to the right or left, the speed of movement of the fringes becomes uniform also.

Similar results are seen in FIG. 5 (upper trace) where these techniques are applied to an experimentally obtained fringe pattern seen in the lower trace.

When FFT is applied to each of the FIGS. 3A and B plots in turn to obtain a phase value for a dominant frequency in each interference pattern and it is considered how the phase values will change if the refractive index of the sample changes, one will arrive at results similar to those shown in FIG. 7, upper and lower panels. FIG. 7 shows in panel A simulated changes in the phase values of the largest amplitude peak in a power spectrum before dechirping in a simulation of BSI fringes with changing sample refractive index. One can observe from FIG. 4 that the maximum peak is not pronounced in comparison with the neighbourhood peaks making it difficult to pick the most representative frequency of the considered fringe pattern. FIG. 7, panel B shows the same changes after the reshaping of the pattern according to the invention. As seen in FIG. 4, in case B we have a clear pronounced peak representing the fringe pattern of interest.

If a figure of merit M is calculated for the fringe patterns shown in FIGS. 3A and 3B respectively over the whole of the fringe pattern (all fringes), the results are as follows:

Original signal Figure of Merit (FIG. 3A) M=0.0166
Unchirped signal Figure of Merit (FIG. 3B) M=0.00043
Improvement factor 38.2

Figure of merit=standard deviation of fringe distance/(mean of fringe distance*number of fringes)

If the figure of merit is calculated on fringes 5-15, the result for FIG. 3A is 0.0160 and for FIG. 3B is 0.0014, i.e. improved by a factor of 11. If M is calculated on the basis of the first 10 fringes, the unchirped result is similar, with the values being FIG. 3A: 0.0351, FIG. 3B: 0.0013.

Each panel of FIG. 7 shows on each ‘step’ the results of 20 simulated measurements, and each step represents a different simulated refractive index being measured. Because little noise has been included in the simulation, all the 20 points on each step of each panel in FIG. 7 are at the same level. The effect of including noise in the simulation will be discussed later below.

One can calculate simulated calibration curves for an RI measurement based on the two instances shown in FIG. 7 and these will be as seen in FIG. 8. Each point in FIG. 8 represents the height of a respective step in FIG. 7 and the upper and lower panels of FIG. 8 derive from the upper and lower panels of FIG. 7 respectively. From these, taking into account the slope of the line (sensitivity) and also the deviation/uncertainty of the points generating the line (R̂2), one can obtain the forecast detection limits for the two cases shown in FIG. 8 and it is found that the detection limit can improve by up to 16 fold through the use of the invention.

FIG. 9 shows the results of a simulation similar to that illustrated by FIG. 7, but with some noise added to the simulation. Now differences between the results of the 20 simulated measurements for each of the seven steps result in the steps appearing somewhat wavy.

Simulated calibration curves are shown in FIG. 10. Each ‘point’ in FIG. 10 is in fact a small cluster of the 20 measurements for each step of FIG. 9. The calculated improvement factor between the simulation of panel A (prior to resampling of the fringe pattern) and panel B (after resampling) is calculated to be 4.7. Here, the improvement in the detection limit DL is mainly due to the improvement in the standard deviation of the measurements at each refractive index value produced by the reshaping. The improvement indicated by FIG. 8 on the other hand comes mainly from an improvement in the linearity of the calibration points upon reshaping the interference pattern.

The offset used above can be estimated and optimised in various ways other than that previously described. It is possible to estimate the offset by determining the angle between the camera position or a CCD array and the incoming laser beam. Also fitting the obtained fringe pattern to a formula D sin(a(x+x_{offset})²+θ)+E can be used to estimate the offset.

For the better understanding of the invention, one may consider a laser beam illuminating a circular cross section channel (chamber) containing a sample liquid. Part of the light is back-reflected from one or more interfaces between the chamber and the surrounding layer(s)—we denote this light reference light. Another part of the light is refracted into the chamber, then reflected within the chamber and refracted out of the chamber—this can be considered as light from the sample “arm”. At a given observation distance one then observes the angular interference pattern I(φ) between the reference light and the sample light.

Iₙ_{₁}(φ)=Aₙ_{₁}(φ)sin [Θₙ_{₁}(φ)]=Aₙ_{₁}(φ)sin [fₙ_{₁}(φ)φ+θₙ_{₁}(φ)]

Here A(φ), f(φ), and θ(φ) denotes the local amplitude, the local frequency and the local phase, respectively, of the angular interference pattern as functions of the angle φ. When the refractive index of the sample liquid is changing within the chamber the interference pattern will change. All of A(φ), f(φ), and θ(φ) will in general be affected.

In order to capture accurate information about the changes in refractive index n₁ of the liquid from observation of changes in the interference pattern, it is essential to understand how a change Δn in affect the interference pattern.

$${I}_{n 1 + Δ n} ( ϕ ) = {A}_{{n}_{1} + Δ n} ( ϕ ) sin [ {Θ}_{{n}_{1} + Δ n} ( ϕ ) ] = {A}_{{n}_{1} + Δ n} ( ϕ ) sin [ {f}_{{n}_{1} + Δ n} ( ϕ ) ϕ + {θ}_{{n}_{1} + Δ n} ( ϕ ) ] = {A}_{{n}_{1} + Δ n} ( ϕ ) sin [ ( {f}_{{n}_{1}} ( ϕ ) + Δ {f}_{Δ n} ( ϕ ) ) ϕ + {θ}_{{n}_{1}} ( ϕ ) + {θ}_{Δ n} ( ϕ ) ]$$

We have used both mathematical modelling based on Maxwell Equations as well as ray tracing to obtain insight into how the fringe pattern behaves and especially how it changes in relation to varying the refractive index of the liquid in the channel.

We observe that for changes in n₁ of order 10⁻² for channels with a diameter in the region of 0.1 mm and above one will locally observe a phase change that is both due to change of frequency and due to a changed optical path length difference of the interfering beams. The optical path length difference arises from the change in refractive index but also due to the different course taken through the liquid when the angle of refraction changes with change in RI. Compared to the detection limit, a change of n₁ of order 10⁻² is large. With such large changes in refractive index one cannot ignore the change in local frequencies if one would like to infer information about these changes. One also finds that for a given value of n₁ the local frequency to a very good approximation has a linear dependency on the angular coordinate. Accordingly we can write:

fₙ_{₁}(φ)≈a(n₁)φ giving:

Iₙ_{₁}(φ)≈Aₙ_{₁}(φ)sin [a(n₁)φ²+θₙ_{₁}(φ)]

This shows that if one could map the observed fringe pattern as function of φ² then for given n₁, one would obtain a fringe pattern with constant frequency.

If one instead considers a change in n₁ of order 10⁻⁶ then with such small change in the refractive index n₁ of the liquid the local frequencies practically do not change. In other words it is only the change in optical path length through the channel that causes the argument of the sinusoidal function to change. Next we have found that the local phase change actually is not constant as function of the angular observation point. But we also observe that the variation in phase change is smallest in the region closest to the zero angular coordinate, i.e. closest to the incoming beam, and we find that with a channel radius of 100 μm the deviation in phase change is around 0.2% within the first 10 degrees. If one increases the ratio between the radius of the channel and the optical wavelength by a factor of 10 (so channel radius=1 mm), the deviation in phase change is still around 0.2% within the first 10 degrees, however the actual phase change is 10 times larger for the same change in n₁. The corresponding local frequencies for this case are increased by a factor of 10 when compared to the case with the smaller channel radius.

What this shows is that there are approximately as many fringes for the latter case when observing the angular region from 0 to 1 degree as are obtained by observing the first 10 degrees of the case with the smaller radius. So by increasing the ratio of the channel radius relative to the optical wavelength one can in general obtain a given number of fringes by observing a smaller angular region. This means that the validity of assuming a constant phase change of the fringe pattern (caused by changes in n) over the considered fringe region is improved. At the same time the actual phase change also becomes larger, thereby increasing the sensitivity of the set-up.

From these simulations and observation above one can learn the following:
The fringe pattern behaves basically as a sinusoidal with constant frequency when mapped relative to the square of the angular coordinate.
For “large” changes in refractive index of the liquid the frequency of this sinusoidal pattern changes significantly.
For “small” changes in refractive index of the liquid the frequency remains constant but the fringes will shift in position due to a phase change caused by changing the optical path length for the light traversing the channel. It is a good approximation to consider this phase change to be constant over many fringes, especially when observing fringes close to the angular origin position.
From modelling work one finds that the frequency changes are governed by light refraction, which changes the angles of the rays escaping from the channel when “large” changes of n occur. Pure phase changes on the other hand are caused by changes in optical path lengths through the sample liquid. For general geometries, diffraction of light may in a similar way cause changes in the local frequencies.
By increasing the ratio of the channel radius to the optical wavelength a given number of fringes will be created within a smaller angular region making it a better approximation to consider the phase change constant over the considered fringes (the reduction in region size scales with the increase in the ratio).
By increasing the ratio of the channel radius to the optical wavelength the phase change obtained for a given change in refractive index n is increased with the same factor, implying improved sensitivity.

Variations in the form of apparatus described herein may be used. For instance, rather than the sample being contained in a tubular, thin walled chamber, the sample chamber might be a cavity within a block such that the interfaces are formed only between the block material and the liquid sample where the light passes into the liquid and where the light passes out of the liquid.

In the embodiment described with reference to FIGS. 3 to 10, the chirp in the fringe pattern has been reduced by mathematical manipulation of the detected fringe spacing.

According to a second aspect of the invention, the observation of the chirp is reduced or eliminated by a change in the optics of the apparatus used to capture the fringe pattern.

As shown in FIGS. 1 and 11, where a spatially extending detector such as a CCD array 16 has been used, it has been customary to arrange it perpendicular to the direct line from the centre of the detector to the cavity 12 containing the fluid sample. We have now appreciated that the chirp previously observed in the fringe pattern on such a detector can be reduced by alternative arrangements of the detector and any intervening optics. Where the light passes directly from the scattering interfaces to the detector, the chirp may be reduced by angling the detector so that it extends at right angles to the light input direction or more preferably at an obtuse angle to it, so that the end of the detector which is nearer to the light input beam is closer to the sample position than is the other end of the detector.

In the case seen in FIG. 11, this means turning the detector from the prior art position shown in full lines to the position marked in dotted lines and labelled 16a or further in the same direction. This places the direction of spatial extension of the detector perpendicular to the reverse of laser output light path or at an obtuse angle to it, whereas in said prior art position it is at an acute angle to the reverse of the light input direction.

In the alternative embodiment shown in FIG. 12, the output light reaches the detector 16 after reflection at a mirror. If the positions of the detector 16 and of a mirror 23 are as shown in full lines, the chirp produced at the detector will be similar to that obtained in the arrangement of FIG. 11 using the detector position shown in full lines. Rotation of the mirror 23 to the position marked 23a or further results in reduction of the chirp. The detector can be moved along to the position shown in dotted lines at 16a or further.

The same principle may be used in the alternative configuration shown in FIG. 13 where a beam splitter 24 is provided in the laser light path to reflect the scattered light from the sample at right angles towards the detector 16. A chirp will be found in the interference pattern on each side of the centroid. This could be reduced on one side of the centroid (but exacerbated on the other side of the centroid) by rotation of the detector to a position as shown at 16a in dotted lines.

FIG. 14 shows the impact on the chirp obtained by rotating the detector axis as described above with reference to FIG. 15 This is illustrated in FIG. 14 by showing the calculated local frequency of the fringe pattern as a function of the detector angle α and the position x of measurement along the detector. α=0 corresponds to no rotation from the dotted line position shown at 16a in FIG. 11. Positive values of a represent positions rotated from α=0 in the direction of the full line representation of the detector. Negative values of α represent rotation of the detector in the opposite sense to be even further away from the full line position than is the dotted line position. x=0 corresponds to measurement of the local frequency at the centroid fringe pattern position of the reflected/scattered pattern of the incoming beam, i.e. on the axis of the laser in FIG. 11. Of course, this cannot actually be on the detector in the arrangement shown in FIG. 11, but it can be in the scheme shown in FIG. 13. Rotating the camera in one direction (to negative values of α) decreases the chirp effect and it is increased by rotating in the other direction, i.e. toward the position shown in full lines at 16. If the plot of local frequency against x is constant, there is no chirp. However, as illustrated, such a rotation cannot fully compensate the chirp, especially not close to the centroid region (small values of x).

This principle is further illustrated in FIGS. 15 and 16. FIG. 16 illustrates three possible detector positions at angles with respect to the light input beam of 90 degrees (α=0) and rotated towards the sample position as in Figure (α at +13.8 degrees) and rotated away from the sample position (α at −13.8 degrees). The light rays from the sample position to successive fringe positions on the detector are shown for each case. The resulting chirp is shown for each case in FIG. 16 where fringe number starting at the centroid as zero is plotted against the spacing of the fringes in arbitrary units (a.u.) for each detector position.

It can be seen that for α=0 and still more for α=−13.8 degrees, the chirp is reduced.

In the use of methods and apparatus according to this second aspect of the invention, the detector and any associated optics may be fixed in an advantageous position or may be mounted for positional adjustment, such as detector rotation. In this latter case, a beneficial position may be experimentally determined by use of a scheme similar to that for estimating the best offset in the coordinate transformation used for the mathematical procedure in the first aspect of the invention, i.e. by picking the rotated detector/mirror position(s) that maximize(s) the peak amplitude value of the power spectrum of the recorded fringe pattern. Thus, with a known size and geometry of the channel containing the sample and a known position and direction of the incoming light beam, one can initially calculate the rotation angle giving minimum chirp or alternatively measure initially what angle gives the minimum chirp.

The method described according to the first aspect of the present invention for compensating the chirp is based on a remapping of the scattering/reflecting angle recorded along one camera or detector axis. This means that one also initially ideally calculates the relationship between the position of the detecting array and the scattering angle measured relative to the centroid region of the scattered/reflected beam. One might use the spatial coordinate position on the detecting array relative to the centroid of the scattered/reflected beam (the centroid position might exist outside the region covered by the detector) as an estimate of the scattering/reflected angle, even if the detecting array is not curved corresponding to an angular distribution of a circular arc defined with its center in the center of the illuminated channel containing the sample being illuminated. It is however clear that the error made by using the position on the detector as estimate of the angle, in general will only be small for sufficiently small angles around the centroid position of the generated fringe pattern. However, in this case the effect of additionally modifying the detected chirped fringe pattern by rotating the camera/detector (or equivalently a mirror along the beam path) can reduce the error caused by the non-ideal relationship between position on the detector and the scattering/reflecting angle.

This is illustrated in FIG. 17. Here, the chirp is reduced by mathematical processing of the fringe pattern according to the first aspect of the invention and then the angle of the detector is varied as in FIG. 11. One observes that compared to FIG. 14, the chirp at α=0° is reduced. However, rotation of the detector produces extra benefit in that the rotation corresponding to α=−13.8 degrees gives lower variation in the local frequency over the considered fringe region than if the camera/detector (or a mirror e.g. as shown in FIG. 12) is not rotated.

From the above discussion it is can also be seen that one could in principle compensate the chirp of the fringe pattern by using an adaptive mirror array in place of the mirror shown in FIG. 12. Such an adaptive mirror array could be made to reflect “each” ray individually in such a way that the pattern produced on the detector would be without chirp.

In this specification, unless expressly otherwise indicated, the word ‘or’ is used in the sense of an operator that returns a true value when either or both of the stated conditions is met, as opposed to the operator ‘exclusive or’ which requires that only one of the conditions is met. The word ‘comprising’ is used in the sense of ‘including’ rather than in to mean ‘consisting of’. All prior teachings acknowledged above are hereby incorporated by reference. No acknowledgement of any prior published document herein should be taken to be an admission or representation that the teaching thereof was common general knowledge in Australia or elsewhere at the date hereof.

The invention may be summarised as in the following clauses:
a) A method for performing a refractive index based measurement of a property of a fluid, comprising
   directing coherent light along an input light path within an apparatus, producing scattering of said light from each of a plurality of interfaces within said apparatus including interfaces between said fluid and a surface bounding said fluid, said scattering producing an interference pattern formed by said scattered light,
   recording varying intensity of light in said pattern in a spatially extending detector crossing the fringes,
   wherein said recorded intensity of light comprises alternating light and dark fringes spaced one from another on at least one side of a centroid position, and in the interference pattern, optionally after mathematical transformation, a figure of merit (M) measured over n fringes contained within the first 15 fringes starting from the centroid position is not greater than 0.005, where n is 10,
   and obtaining a said refractive index based measurement from said optionally mathematically transformed recorded intensity, M being calculated according to the formula:

M=standard deviation of fringe spacing/(mean spacing of fringes*number of fringes(n)).
b) A method for performing a refractive index based measurement of a property of a fluid, comprising
   directing coherent light along an input light path within an apparatus, producing scattering of said light from each of a plurality of interfaces within said apparatus including interfaces between said fluid and a surface bounding said fluid, said scattering producing an interference pattern formed by said scattered light,
   recording varying intensity of light in said pattern in a spatially extending detector crossing fringes of said interference pattern,
   mathematically transforming said recorded varying intensity of light in said pattern to reduce or remove a chirp in a local spatial frequency of fringes exhibited by said pattern at the detector and thereby producing a modified intensity variation,
   and obtaining a said refractive index based measurement from said modified intensity variation.
c) A method as defined in clause 2, wherein said recorded intensity of light comprises alternating light and dark fringes spaced one from another on at least one side of a centroid position, and in the interference pattern, after said mathematical transformation, a figure of merit (M) measured over n fringes contained within the first 15 fringes starting from the centroid position is not greater than 0.005, where n is 10, M being calculated according to the formula:

M=standard deviation of fringe spacing/(mean spacing of fringes*number of fringes(n)).
d) A method as defined in clause 2 or clause 3, wherein said mathematically transforming step is performed in a suitably pre-programmed computation apparatus.
e) A method as defined in any one of clauses 2 to 4, wherein said mathematically transforming step is conducted by applying a coordinate transformation to said recorded varying intensity of light along the detector.
f) A method as defined in clause 5, wherein a frequency spectrum is obtained for the spatial frequencies in said recorded intensity, a maximum peak amplitude value of said frequency spectrum is determined, a first offset value (x_{offset}) is chosen by which to transform a coordinate (x) of intensity values in said recorded varying intensity of light along the detector and said coordinate transformation is carried out using said first offset value, the frequency spectrum and the peak amplitude value thereof are obtained again and compared with their previous values and the process is repeated using different offset values to obtain a value of the offset value that increases the maximum peak amplitude value.
g) A method as defined in clause 6, wherein the chosen offset is obtained by measurement carried out on the apparatus.
h) A method as defined in any preceding clause, wherein the detector and any optics intervening between the detector and the said interfaces are so arranged that said chirp in the local spatial frequency at the detector prior to said mathematical transformation is no greater than would be observed if the intensity of light following said output paths was recorded on a detector extending orthogonally to said input light path without any optics intervening between the said detector and said interfaces.
i) A method as defined in clause 8, wherein a frequency spectrum is obtained for the spatial frequencies in said recorded intensity, the arrangement of the detector and any optics intervening between the detector and the said interfaces is adjusted, the frequency spectrum and the peak amplitude value thereof are obtained again and compared with their previous values and the process is repeated to obtain a said arrangement that increases the maximum peak amplitude value.
j) A method as defined in clause 9, wherein an offset value is selected that provides the maximum value obtained for the maximum peak amplitude value.
k) A method as defined in clause 10, wherein the adjustment of said arrangement of the detector and any optics intervening between the detector and the said interfaces is a rotation of the detector or a rotation of a reflective optical component intervening between the detector and said interfaces.
l) A method for performing a refractive index based measurement of a property of a fluid, comprising
   directing coherent light along an input light path within an apparatus, producing scattering of said light along output paths from each of a plurality of interfaces within said apparatus including interfaces between said fluid and a surface bounding said fluid, said scattering producing an interference pattern formed by said scattered light which has a local spatial frequency,
   recording varying intensity of light in said pattern in a spatially extending detector crossing the fringes,
   wherein the detector and any optics intervening between the detector and the said interfaces are so arranged that a chirp in the local spatial frequency observed at the detector is no greater than would be observed if the intensity of light following said output paths was recorded on a detector extending orthogonally to said input light path without any optics intervening between the said detector and said interfaces,
   and obtaining a said refractive index based measurement from said recorded intensity variation.
m) A method as defined in clause 12, wherein said recorded intensity of light comprises alternating light and dark fringes spaced one from another on at least one side of a centroid position, and in the interference pattern, after said mathematical transformation, a figure of merit (M) measured over n fringes contained within the first 15 fringes starting from the centroid position is not greater than 0.005, where n is 10, M being calculated according to the formula:

M=standard deviation of fringe spacing/(mean spacing of fringes*number of fringes(n)).
n) A method as defined in clause 12 or clause 13, wherein a frequency spectrum is obtained for the spatial frequencies in said recorded intensity, the arrangement of the detector and any optics intervening between the detector and the said interfaces is adjusted, the frequency spectrum and the peak amplitude value thereof are obtained again and compared with their previous values and the process is repeated to obtain a said arrangement that increases the maximum peak amplitude value.
o) A method as defined in clause 14, wherein the adjustment of said arrangement of the detector and any optics intervening between the detector and the said interfaces is a rotation of the detector or a rotation of a reflective optical component intervening between the detector and said interfaces.
p) A method as defined in any preceding clause, wherein said apparatus includes a flow path for the supply of a fluid to a location where the fluid meets the input light path and a flow path for removal of said fluid from said location.
q) A method as defined in clause 16, further comprising the step of driving a flow of fluid through said location.
r) A method as defined in any preceding clause, further comprising operating a temperature control means to maintain said fluid at a desired constant or varying temperature.
s) A method as defined in any preceding clause, wherein the interference pattern is detected at a position where it is formed by backscattered light.
t) Apparatus for use in performing a refractive index based measurement of a property of a fluid, by a method comprising directing coherent light along an input light path within said apparatus, producing scattering of said light from each of a plurality of interfaces within said apparatus including interfaces between said fluid and a surface bounding said fluid, and detecting properties of an interference pattern formed by said scattered light which interference pattern has a local spatial frequency of fringes exhibiting a chirp,
   wherein said apparatus comprises
   a source of coherent light for directing light along an input light path, at least one cavity in said input light path for containing a said fluid and defining said plurality of interfaces, a spatially extending detector positioned to sense light forming a said interference pattern of fringes produced by scattering from said interfaces in use and to produce an electronic output in response thereto which provides a recording of varying intensity of light in said interference pattern with respect to a spatial direction crossing the fringes, and computation means operatively connected to receive said electronic output for determining therefrom said measured property, said computation means being pre-programmed to remove or reduce a said chirp exhibited by a spatial frequency of recorded fringes in said recording by a method comprising mathematically transforming said recorded varying intensity of light in said pattern to reduce or remove said chirp and thereby to produce a modified intensity variation, and obtain a said refractive index based measurement from said modified intensity variation.
u) Apparatus as defined in clause 20, wherein the detector and any optics intervening between the detector and the said interfaces are so arranged that said chirp in the local spatial frequency at the detector prior to said mathematical transformation is no greater than would be observed if the intensity of light following said output paths was recorded on a detector extending orthogonally to said input light path without any optics intervening between the said detector and said interfaces.
v) Apparatus for use in performing a refractive index based measurement of a property of a fluid, by a method comprising directing coherent light along an input light path within said apparatus, producing scattering of said light from each of a plurality of interfaces within said apparatus including interfaces between said fluid and a surface bounding said fluid, and detecting properties of an interference pattern formed by said scattered light which interference pattern has a spatial frequency of fringes exhibiting a chirp,
   wherein said apparatus comprises
   a source of coherent light for directing light along an input light path, at least one cavity in said input light path for containing a said fluid and defining said plurality of interfaces, a spatially extending detector positioned to sense light forming a said interference pattern of fringes produced by scattering from said interfaces in use and to produce an electronic output in response thereto which provides a recording of varying intensity of light in said interference pattern with respect to a spatial direction crossing the fringes, wherein the detector and any optics intervening between the detector and the said interfaces are so arranged that said chirp in the local spatial frequency at the detector prior to said mathematical transformation is no greater than would be observed if the intensity of light following said output paths was recorded on a detector extending orthogonally to said input light path without any optics intervening between the said detector and said interfaces, and computation means operatively connected to receive said electronic output and to obtain a said refractive index based measurement therefrom.
w) Apparatus as defined in any one of clauses 20 to 22, wherein the said cavity containing said fluid has a transverse dimension in the direction of the input light path of from 1 μm to 10 mm.
x) Apparatus as defined in clause 23, wherein the said cavity containing said fluid has a transverse dimension in the direction of the input light path of from 0.5 to 3 mm.
y) Apparatus as defined in any one of clauses 20 to 24, wherein said apparatus includes a flow path for the supply of a fluid to said cavity and a flow path for removal of said fluid from said cavity.
z) Apparatus as defined in clause 25, further comprising means for driving a flow of fluid through said cavity.
aa) Apparatus as defined in any one of clauses 20 to 26, further comprising a temperature control for maintaining said fluid at a desired constant or variable temperature.

1. A method for performing a refractive index based measurement of a property of a fluid, comprising:
directing coherent light along an input light path within an apparatus, producing scattering of said light from each of a plurality of interfaces within said apparatus including interfaces between said fluid and a surface bounding said fluid, said scattering producing an interference pattern formed by said scattered light,
recording varying intensity of light in said pattern in a spatially extending detector crossing the fringes,
wherein said recorded intensity of light comprises alternating light and dark fringes spaced one from another on at least one side of a centroid position, and in the interference pattern, optionally after mathematical transformation, a figure of merit (M) measured over n fringes contained within the first 15 fringes starting from the centroid position is not greater than 0.005, where n is 10,
and obtaining a said refractive index based measurement from said optionally mathematically transformed recorded intensity, M being calculated according to the formula:
M=standard deviation of fringe spacing/(mean spacing of fringes*number of fringes(n)).

2. A method for performing a refractive index based measurement of a property of a fluid, comprising:
directing coherent light along an input light path within an apparatus, producing scattering of said light from each of a plurality of interfaces within said apparatus including interfaces between said fluid and a surface bounding said fluid, said scattering producing an interference pattern formed by said scattered light,
recording varying intensity of light in said pattern in a spatially extending detector crossing fringes of said interference pattern,
mathematically transforming said recorded varying intensity of light in said pattern to reduce or remove a chirp in a local spatial frequency of fringes exhibited by said pattern at the detector and thereby producing a modified intensity variation,
and obtaining a said refractive index based measurement from said modified intensity variation.

3. A method as claimed in claim 2, wherein said recorded intensity of light comprises alternating light and dark fringes spaced one from another on at least one side of a centroid position, and in the interference pattern, after said mathematical transformation, a figure of merit (M) measured over n fringes contained within the first 15 fringes starting from the centroid position is not greater than 0.005, where n is 10, M being calculated according to the formula:
M=standard deviation of fringe spacing/(mean spacing of fringes*number of fringes(n)).

4. A method as claimed in claim 2, wherein said mathematically transforming step is conducted by applying a coordinate transformation to said recorded varying intensity of light along the detector.

5. A method as claimed in claim 4, wherein a frequency spectrum is obtained for the spatial frequencies in said recorded intensity, a maximum peak amplitude value of said frequency spectrum is determined, a first offset value (x_{offset}) is chosen by which to transform a coordinate (x) of intensity values in said recorded varying intensity of light along the detector and said coordinate transformation is carried out using said first offset value, the frequency spectrum and the peak amplitude value thereof are obtained again and compared with their previous values and the process is repeated using different offset values to obtain a value of the offset value that increases the maximum peak amplitude value.

6. A method as claimed in claim 1, wherein the detector and any optics intervening between the detector and the said interfaces are so arranged that said chirp in the local spatial frequency at the detector prior to said mathematical transformation is no greater than would be observed if the intensity of light following said output paths was recorded on a detector extending orthogonally to said input light path without any optics intervening between the said detector and said interfaces.

7. A method as claimed in claim 6, wherein a frequency spectrum is obtained for the spatial frequencies in said recorded intensity, the arrangement of the detector and any optics intervening between the detector and the said interfaces is adjusted, the frequency spectrum and the peak amplitude value thereof are obtained again and compared with their previous values and the process is repeated to obtain a said arrangement that increases the maximum peak amplitude value.

8. A method as claimed in claim 7, wherein the adjustment of said arrangement of the detector and any optics intervening between the detector and the said interfaces is a rotation of the detector or a rotation of a reflective optical component intervening between the detector and said interfaces.

9. A method for performing a refractive index based measurement of a property of a fluid, comprising
directing coherent light along an input light path within an apparatus, producing scattering of said light along output paths from each of a plurality of interfaces within said apparatus including interfaces between said fluid and a surface bounding said fluid, said scattering producing an interference pattern formed by said scattered light which has a local spatial frequency,
recording varying intensity of light in said pattern in a spatially extending detector crossing the fringes,
wherein the detector and any optics intervening between the detector and the said interfaces are so arranged that a chirp in the local spatial frequency observed at the detector is no greater than would be observed if the intensity of light following said output paths was recorded on a detector extending orthogonally to said input light path without any optics intervening between the said detector and said interfaces,
and obtaining a said refractive index based measurement from said recorded intensity variation.

10. A method as claimed in claim 9, wherein a frequency spectrum is obtained for the spatial frequencies in said recorded intensity, the arrangement of the detector and any optics intervening between the detector and the said interfaces is adjusted, the frequency spectrum and the peak amplitude value thereof are obtained again and compared with their previous values and the process is repeated to obtain a said arrangement that increases the maximum peak amplitude value.

11. Apparatus for use in performing a refractive index based measurement of a property of a fluid, by a method comprising directing coherent light along an input light path within said apparatus, producing scattering of said light from each of a plurality of interfaces within said apparatus including interfaces between said fluid and a surface bounding said fluid, and detecting properties of an interference pattern formed by said scattered light which interference pattern has a local spatial frequency of fringes exhibiting a chirp,
wherein said apparatus comprises
a source of coherent light for directing light along an input light path, at least one cavity in said input light path for containing a said fluid and defining said plurality of interfaces, a spatially extending detector positioned to sense light forming a said interference pattern of fringes produced by scattering from said interfaces in use and to produce an electronic output in response thereto which provides a recording of varying intensity of light in said interference pattern with respect to a spatial direction crossing the fringes, and computation means operatively connected to receive said electronic output for determining therefrom said measured property, said computation means being pre-programmed to remove or reduce a said chirp exhibited by a spatial frequency of recorded fringes in said recording by a method comprising mathematically transforming said recorded varying intensity of light in said pattern to reduce or remove said chirp and thereby to produce a modified intensity variation, and obtain a said refractive index based measurement from said modified intensity variation.

12. Apparatus for use in performing a refractive index based measurement of a property of a fluid, by a method comprising directing coherent light along an input light path within said apparatus, producing scattering of said light from each of a plurality of interfaces within said apparatus including interfaces between said fluid and a surface bounding said fluid, and detecting properties of an interference pattern formed by said scattered light which interference pattern has a spatial frequency of fringes exhibiting a chirp,
wherein said apparatus comprises
a source of coherent light for directing light along an input light path, at least one cavity in said input light path for containing a said fluid and defining said plurality of interfaces, a spatially extending detector positioned to sense light forming a said interference pattern of fringes produced by scattering from said interfaces in use and to produce an electronic output in response thereto which provides a recording of varying intensity of light in said interference pattern with respect to a spatial direction crossing the fringes, wherein the detector and any optics intervening between the detector and the said interfaces are so arranged that said chirp in the local spatial frequency at the detector prior to said mathematical transformation is no greater than would be observed if the intensity of light following said output paths was recorded on a detector extending orthogonally to said input light path without any optics intervening between the said detector and said interfaces,
and computation means operatively connected to receive said electronic output and to obtain a said refractive index based measurement therefrom.

13. Apparatus as claimed in claim 12, wherein the said cavity containing said fluid has a transverse dimension in the direction of the input light path of from 0.5 to 3 mm.

14. Apparatus as claimed in claim 11, wherein said apparatus includes a flow path for the supply of a fluid to said cavity and a flow path for removal of said fluid from said cavity.

15. Apparatus as claimed in claim 11, further comprising a temperature control for maintaining said fluid at a desired constant or variable temperature.
